(19) United States
(12) Patent Application Publication
(10) Pub. No.: US 2012/0275279 A1
(43) Pub. Date: Nov. 1, 2012

(54) Systems and Methods for Laser Write Control

(75) Inventors: Ross S. Wilson, Menlo Park, CA (US); Donald C. Grillo, Lakeville, MN (US)

(73) Assignee: LSI Corporation

(21) Appl. No.: 13/096,900

(22) Filed: Apr. 28, 2011

(51) Int. Cl. G11B 5/02; G11B 13/04

(52) U.S. Cl. 369/13.24; 360/59; G9B/5.026; G9B/13.002

(57) ABSTRACT

Various embodiments of the present invention provide systems and methods for data writing. As an example, a heat assisted data write circuit is discussed that includes a heat write output, a magnetic write output, and a variable phase shift circuit operable to modify a relative phase of the heat write output to the magnetic write output.

### BACKGROUND OF THE INVENTION

The present inventions are related to systems and methods for writing data to a storage medium.

In conventional recording systems there is a tradeoff between the longevity of data stored to a storage medium and the writeability of the storage medium. Small grain size is required for high-density recording. Such small grain size renders the stored data more susceptible to thermal agitation resulting in destruction of the magnetization representing the stored data. In some cases, medium coercivity is increased to mitigate the aforementioned effect of thermal agitation, but such an increase in coercivity has not proven able to surpass values magnetizable by about two Tesla flux densities, a limit imposed by the saturation magnetization of the soft magnetic materials of which the write head is fabricated. The aforementioned issues are discussed more fully in, D. Weller et al., “Thermal Limits in Ultrahigh-Density magnetic Recording”, IEEE Trans. Magn., VOl. 35, No. 6, p. 4423, November 1999. The entirety of the aforementioned reference is incorporated herein by reference for all purposes.

Use of heat-assisted magnetic recording addresses the writeability versus longevity dilemma by locally heating the storage medium during writing to near its Curie temperature allowing magnetization by existing write head designs relying on achievable flux densities. In some cases, the heating is done using a concentrated laser beam typically of 800 nm-1000 nm wavelength; beam concentration below the diffraction limit is typically achieved using near-field techniques based on plasmon resonance. Such an approach is more fully described in M. Kryder et al., “Heat Assisted Magnetic Recording”, Proc. IEEE, Vol. 96, November 2008, p. 1810. The entirety of the aforementioned reference is incorporated herein by reference for all purposes. While such an approach offers promise of improved data storage devices and systems, current control of the laser in relation to other write circuitry has been insufficient to yield commercially viable systems.

Hence, for at least the aforementioned reasons, there exists a need in the art for advanced systems and methods for control of the laser relative to other write circuitry.

### BRIEF SUMMARY OF THE INVENTION

The present inventions are related to systems and methods for writing data to a storage medium.

Various embodiments of the present invention provide heat assisted data write circuits. Such heat assisted data write circuits include a heat write output, a magnetic write output, and a variable phase shift circuit operable to modify a relative phase of the heat write output to the magnetic write output. In some instances of the aforementioned embodiments, the circuits further include a programmable phase shift value register operable to maintain a phase shift value. In such instances, a delay implemented by the variable phase shift circuit corresponds to the phase shift value.

In one or more instances of the aforementioned embodiments, a derivative of the magnetic write output is provided as an excitation signal a write head, and a derivative of the heat write output is provided as an excitation signal a heat source. As used herein, the term “derivative” is used in its broadest sense to mean anything derived from another thing and is, inter alia, not limited to its mathematical definition. Thus, for example, a signal that is a derivative of another signal may be the original signal after passing through one or more circuits and/or being combined with one or more signals, or may be the same signal. In some such instances, the circuits may further include a phase detector circuit operable to determine a phase offset between the heat write output and the magnetic write output, and a controller circuit operable to determine the phase shift value based at least in part on the phase offset between the heat write output and the magnetic write output, and to store the phase shift value to the programmable phase shift value register. In some cases, the write head is a magneto-resistive write head, and the heat source is a laser. In various instances of the aforementioned embodiments, the circuits further include a fixed phase shift circuit operable to apply a fixed phase shift to one of the heat write output and the magnetic write output. In such instances, the variable phase shift circuit is operable to apply a variable phase shift to the other of the heat write output and the magnetic write output. As such, it may be possible to introduce both leading and lagging phase shift of the heat signal relative to the magnetic signal.

In particular instances of the aforementioned embodiments, the circuit further include a heat pre-write emphasis circuit operable to emphasize at least one transition of the heat write output. In such instances, the circuits may further include a heat source, and an output driver operable to receive the heat write output and to drive an excitation signal corresponding to the heat write output to the heat source. In some cases, the transition is a positive transition, the heat source is a laser, and the emphasis is an overshoot designed to cause the laser to turn on more quickly than would occur in the absence of the overshoot. In one or more cases, the transition is a negative transition, the heat source is a laser, and the emphasis is an undershoot designed to cause the laser to turn off more quickly than would occur in the absence of the undershoot. A composite of both positive and negative transitions may also be used.

Other embodiments of the present invention provide methods for performing phase alignment in a recording channel. Such methods include: providing a data pattern to both a magnetic write circuit operable to provide a magnetic write signal used to excite a write head and a heat write circuit operable to provide a heat write signal used to excite a heat source; determining a phase offset between the heat write signal and the magnetic write signal; and performing a phase shift of one of the heat write signal and the magnetic write signal such that the phase offset is reduced.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a storage system including a read channel circuit with a phase controlled heat write circuit in accordance with some embodiments of the present invention;

FIG. 2 depicts a write portion of a heat assisted magnetic recording system in accordance with one or more embodiments of the present invention;

FIG. 3 shows an implementation of a pre-amplifier circuit including a phase offset detector in accordance with various embodiments of the present invention;

FIGS. 4a-4c show examples of phase offset detector circuits that may be used in relation to different embodiments of the present invention;

FIG. 5 is a flow diagram showing a method in accordance with some embodiments of the present invention for performing phase alignment in a recording channel;

FIG. 6 depicts a write portion of a heat assisted magnetic recording system including both phase alignment control and a heat write pre/post emphasis circuit in accordance with one or more embodiments of the present invention; and

FIG. 7 is a timing diagram showing pre/post emphasis on a heat write in accordance with various embodiments of the present invention; and

FIG. 8 shows a pre/post emphasis circuit in accordance with one or more embodiments of the present invention; and

FIG. 9 depicts an implementation of a pre-amplifier circuit including a phase offset detector and phase delay circuits is shown in accordance with some embodiments of the present invention.

### DETAILED DESCRIPTION OF THE INVENTION

The present inventions are related to systems and methods for writing data to a storage medium.

Some embodiments of the present invention operate to control the phase alignment of a laser pulse used for locally heating a storage medium with a write current flowing in a magnetic recording head used for locally magnetizing the storage medium. In some such cases, such approaches yield a laser pulse that is coherent with the write current. In particular embodiments, circuitry offering such control of the phase alignment is implemented in a read channel circuit, a read/write head assembly, flexible transmission lines connecting the read channel circuit and the read/write head assembly, receiving circuits, high-power driver/amplifier circuits, or a combination or sub-combination of the aforementioned. Of note, control of the phase alignment may be implemented downstream in a pre-amplifier circuit. Transport lag through the various circuitry and connectors is sensitive to temperature, humidity, and/or process variation, and such sensitivity may differ between the magnetic and optical paths due to dissimilar electronic circuitry required to drive the inductive recording head and the laser diode, and to encode magnetic write and laser data within the recording channel. Some instances of the aforementioned embodiments provide means to account for difference in the transport lag such that a reasonably fixed phase relationship between the optical and magnetic paths can be achieved. Such a fixed relationship operates, among other things, to enhance enhancing recording performance of heat-assisted magnetic recording. One or more instances of the aforementioned embodiments additionally allows for introduction of pre or post emphasis to reduce laser switching time and reduce jitter of the laser output.

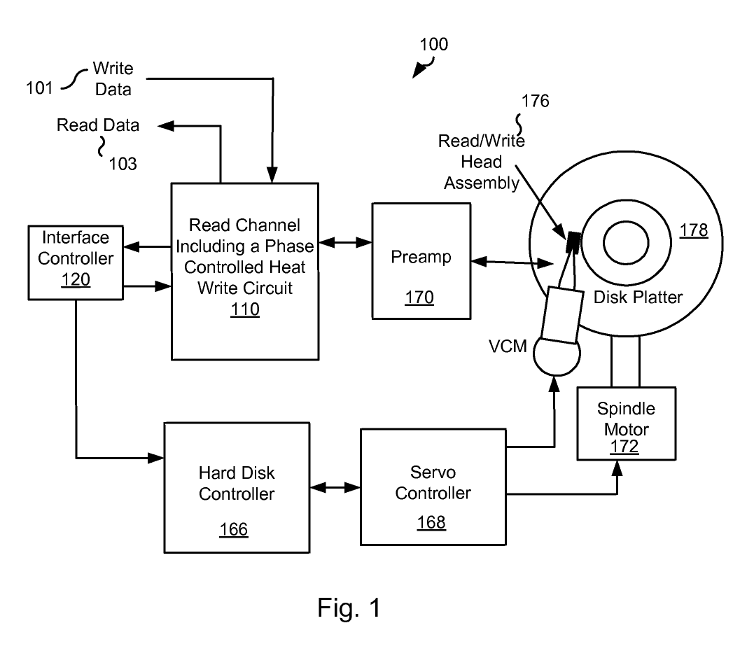

Turning to FIG. 1 depicts a data storage system 100 that may be, for example, a hard disk drive. Data storage system 100 includes a read channel circuit 110 having a phase controlled heat write circuit in accordance with various embodiments of the present invention. The phase controlled heat write circuit includes an ability to control the phase alignment of a heat source and a magnetic source in a read/write head assembly 176. In some embodiments, the heat source is a laser. In one particular embodiment of the present invention, the laser is a 50 mW, 830 nm laser diode. Such alignment control enhances the write effectiveness of read/write head assembly as it writes information to a disk platter 178. It should be noted that data storage system 100 may include many disk platters with one or more read/write head assemblies associated with each disk platter. As just one example, data storage system 100 may include four disk platters and eight read/write head assemblies respectively associated with each of the eight storage surfaces of the four disk platters. Based upon the disclosure provided herein, one of ordinary skill in the art will recognize a variety of number of disk platters and read/writer head assemblies, and configurations thereof that may be used in relation to different embodiments of the present invention.

Data storage system 100 also includes a pre-amplifier 170, an interface controller 120, a hard disk controller 166, a servo controller 168, and a spindle motor 172. Interface controller 120 controls addressing and timing of data to/from disk platter 178. The data on disk platter 178 consists of groups of magnetic signals that may be detected by read/write head assembly 176 when the assembly is properly positioned over disk platter 178. In one embodiment, disk platter 178 includes magnetic signals recorded in accordance with either a longitudinal or a perpendicular recording scheme.

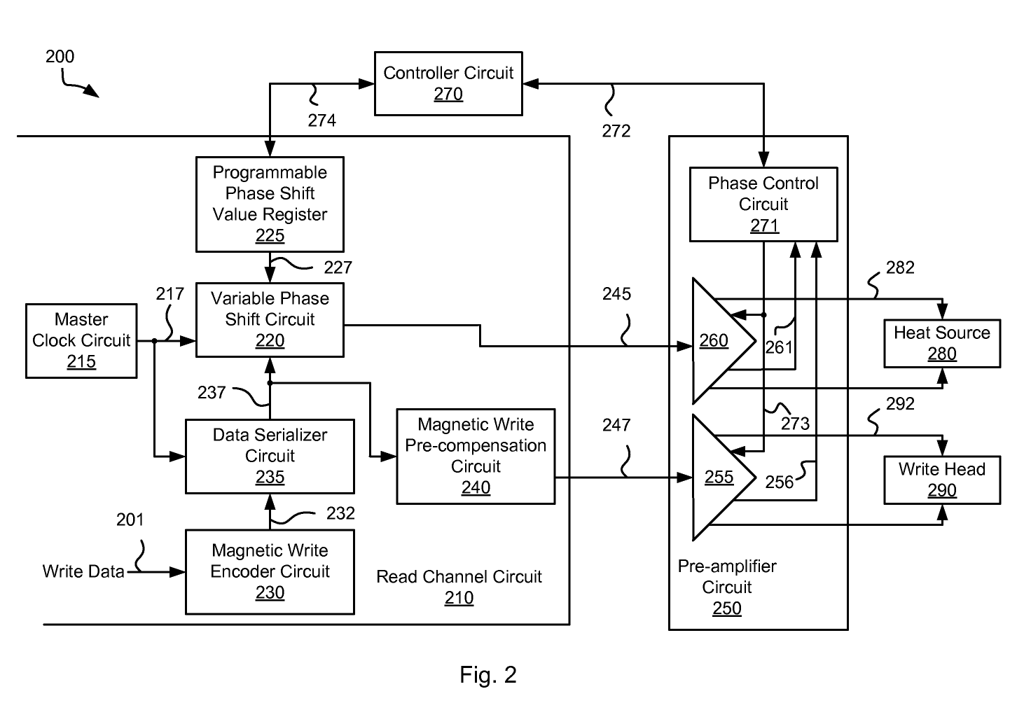

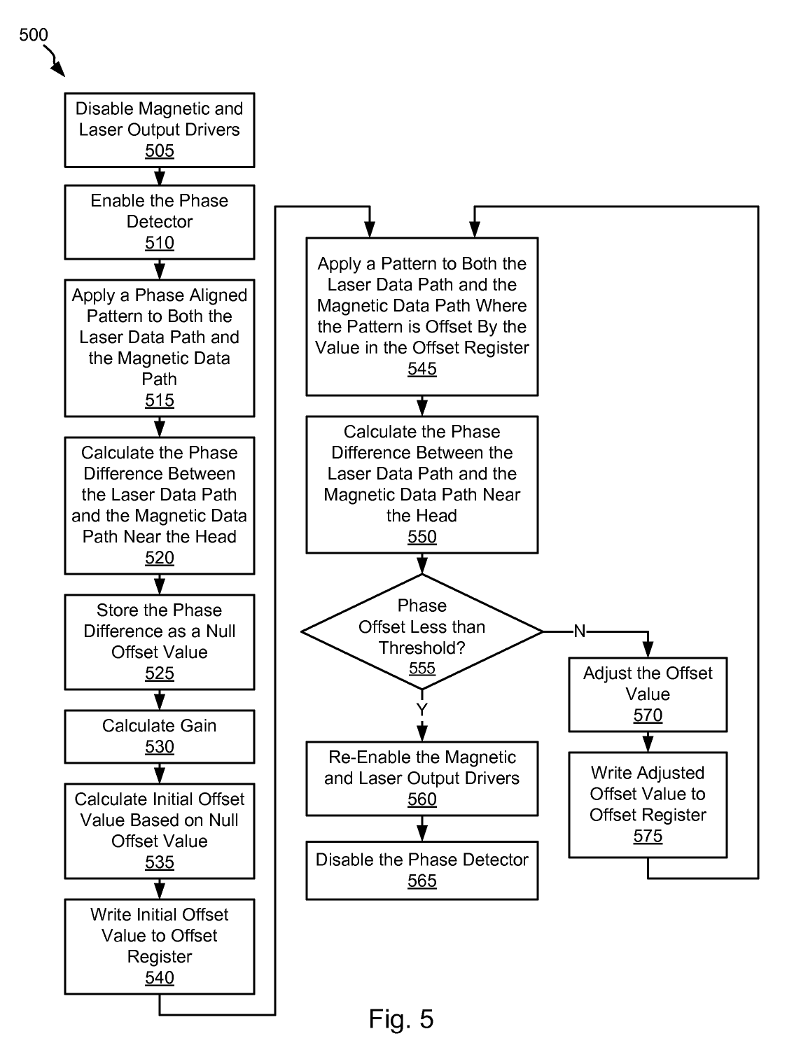

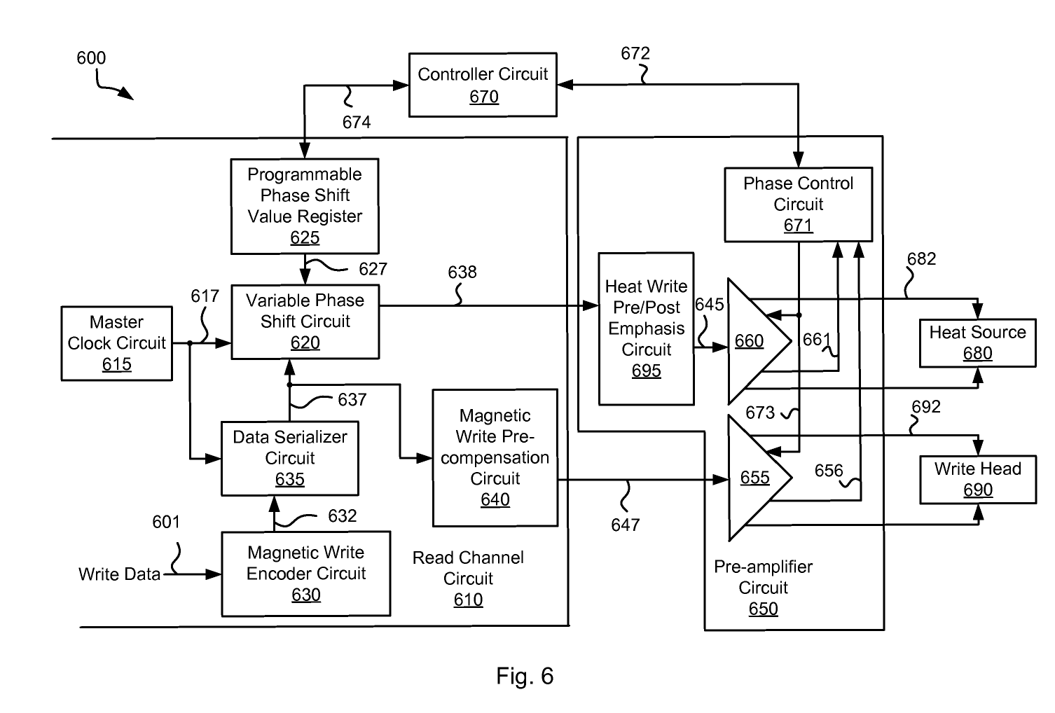

In a typical write operation, read/write head assembly 176 is accurately positioned by servo controller 168 over a desired data track on disk platter 178. Servo controller 168 both positions read/write head assembly 176 in relation to disk platter 178 and drives spindle motor 172 by moving read/write head assembly 178 to the proper data track on disk platter 178 under the direction of hard disk controller 166. Spindle motor 172 spins disk platter 178 at a determined rotation rate, which may be, but is not limited to, 7200 RPMs. Once read/write head assembly 178 is positioned adjacent the proper data track, a magnetic field is generated in read/write head assembly causing the surface of disk platter to be magnetized with a field corresponding to a write data 101 input (after encoding and processing by read channel circuit 110). At the same time, the area on disk platter 178 where the data are to be written is heated using a heat source to allow for enhanced writeability. In a read process, magnetic signals representing data on disk platter 178 are sensed by read/write head assembly 176 as disk platter 178 is rotated by spindle motor 172. The sensed magnetic signals are provided as a continuous, low amplitude analog signal representative of the magnetic data on disk platter 178. This low amplitude analog signal is transferred from read/write head assembly 176 to read channel circuit 110 via pre-amplifier 170. Pre-amplifier 170 is operable to amplify the low amplitude analog signals accessed from disk platter 178. In turn, read channel circuit 110 decodes and digitizes the received analog signal to recreate the information originally written to disk platter 178. These data are provided as read data 103 to a receiving circuit. The heat source and magnetic source may be phase aligned or phase offset in a controlled manner using write circuitry similar to that discussed below in relation to FIGS. 2-4, and 9, and/or methods consistent with that discussed below in relation to FIG. 5. Further, in some cases, the heat source may be pre/post emphasized by a pre/post emphasis circuit similar to that discussed below in relation to FIGS. 6-8. It should be noted that while in FIG. 1 phase control of the heat write circuit is implemented as part of read channel circuit 110 that it may be implemented in other blocks including, but not limited to pre-amplifier 170.

In some cases, storage system 100 may be integrated into a larger storage system such as, for example, a RAID (redundant array of inexpensive disks or redundant array of independent disks) based storage system. It should also be noted that various functions or blocks of storage system 100 may be implemented in either software or firmware, while other functions or blocks are implemented in hardware.

Turning to FIG. 2, a write portion 200 of a heat assisted magnetic recording system is shown in accordance with one or more embodiments of the present invention. Write portion 200 includes a portion of a read channel circuit 210, a portion of a pre-amplifier circuit 250, a heat source 280, and a write head 290. Write head 290 and heat source 280 are disposed near the surface of a storage medium (not shown) and a used to write data to the storage medium. Write head 290 may be any circuit or device known in the art that is capable of generating a magnetic field sufficiently large to magnetize a defined region of the storage medium. As just one example, write head 290 may be a magneto-resistive (MR) write head as are known in the art. Based upon the disclosure provided herein, one of ordinary skill in the art will recognize a variety of write heads that may be used in relation to different embodiments of the present invention. In some embodiments of the present invention, heat source 280 is a laser as is known in the art. When excited, the laser generates heat at the defined location where a write is occurring. Based upon the disclosure provided herein, one of ordinary skill in the art will recognize a variety of heat sources including, but not limited to, specific types of lasers that may be used in relation to different embodiments of the present invention.

A controller circuit 270 is included that provides control signals 272 to pre-amplifier circuit 250, and control signals 274 to read channel circuit 210. Control circuit 270 may be any circuit capable of providing control to the operations of write portion 200. In some embodiments of the present invention, control circuit 270 includes a microcontroller that executes firmware as are known in the art. Based upon the disclosure provided herein, one of ordinary skill in the art will recognize a variety of control circuits that may be used in relation to different embodiments of the present invention.

Read channel circuit 210 includes a master clock circuit 215 that generates a clock signal 217 to which write operations are synchronized. In some cases, the phase and frequency of clock signal 217 are adjusted by master clock circuit 215 based upon servo data read from the storage medium. Based upon the disclosure provided herein, one of ordinary skill in the art will recognize a variety of clock circuits that may be used in relation to different embodiments of the present invention.

Write data 201 destined for storage to the storage medium may be received from an upstream source (not shown). Such write data may be received either serially or in parallel as a series of WORDS which each contain a number of individual bits. Such WORDS may be, but are not limited to, thirty-two bit words, sixty-four bit words, or one hundred, twenty-eight bit words. Based upon the disclosure provided herein, one of ordinary skill in the art will recognize a variety of source from which write data 201 may be received, and a number of formats that write data 201 may exhibit. Write data 201 is received by a magnetic write encoder circuit 230 and encoded in preparation for writing as magnetic information on a storage medium. The resulting data are provided as encoded data 232 to a data serializer circuit 235. Magnetic write encoder circuit 230 may be any circuit known in the art that receives data and encodes that data in preparation for writing as magnetic information to a storage medium. Data serializer circuit 235 accepts encoded data 232 at an input clock rate, and provides a serial data stream 237 at an output clock rate. As an example, where encoded data are received eight bits at a time, serial data stream 237 may be provided at eight times the rate of the input clock.

Serial data stream 237 is provided to a magnetic write pre-compensation circuit 240 that pre-compensates the received data and provides a pre-compensated write signal 247 to pre-amplifier circuit 250. It is customary to pre-compensate the magnetic write data signal to counteract the bit-shift effect of adjacent transition patterns, and magnetic write pre-compensation circuit 240 may be any circuit known in the art that is capable of pre-compensating a data input in preparation for writing to a storage medium. Of note, in some embodiments read channel circuit 210 and pre-amplifier circuit 250 are implemented in separate physical packages. In some such cases, pre-compensated write signal 247 is provided to pre-amplifier circuit 250 via a flexible connector or transmission line. While it is not shown, in some embodiments of the present invention, heat data may also be pre-compensated. In such cases, read channel circuit 210 would additionally include a heat data pre compensation circuit.

In addition, serial data stream 237 is provided to a variable phase shift circuit 220 that operates to phase delay serial data stream 237 in time according to a phase delay value 227 to yield a heat write signal 245. This applied phase delay operates to modify the relative alignment of heat write signal 245 and pre-compensated write signal 247 in accordance with the following equation:

Phase Offset=φ_{Heat Write Signal}−φ_{Pre-Compensated Write Signal},

where φ_{Heat Write Signal} is the phase of heat write signal 245 and φ_{Pre-Compensated Write Signal} is the phase of pre-compensated write signal 247. Of note, as depicted only a positive phase shift is possible as variable phase shift circuit 220 only applies a phase delay to serial data stream 237. However, in some embodiments of the present invention, magnetic write pre-compensation circuit 240 applies a fixed delay to serial data stream 237 as part of generating pre-compensated write signal 247. As such, where variable phase shift circuit 220 applies a phase delay less than the fixed delay applied by magnetic write pre-compensation circuit 240, an effective negative delay can be applied to heat write signal 245 in accordance with the following equation:

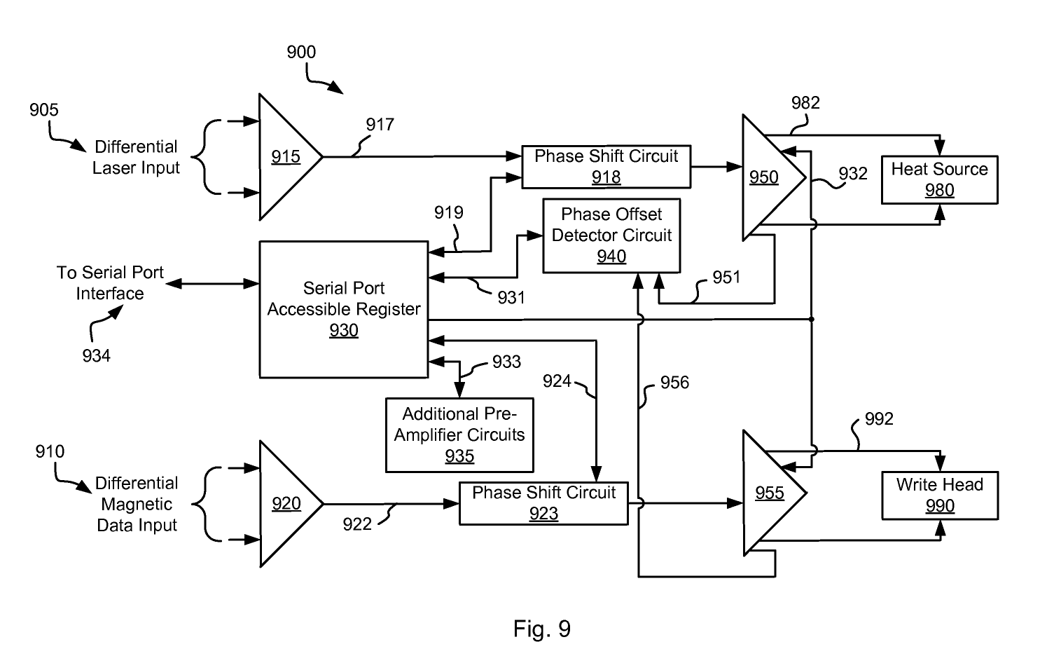

Phase Offset=φ_{Heat Write Signal}−φ_{Pre-Compensated Write Signal}+φ_{Fixed},

where φ_{Fixed} is the fixed delay applied by magnetic write pre-compensation circuit 240. Phase delay value 227 is written to a programmable phase shift value register 225 by controller circuit 270 as part of a calibration process that is more fully described below. It should be noted that variable phase shift circuit 220 may be implemented in pre-amplifier circuit 250 instead of read channel circuit 210, thus implementing the controlled delay nearer the output to heat source 280 and write head 290. An example of implementation of phase shift circuits in the pre-amplifier circuit is discussed below in relation to FIG. 9 where the function of variable phase shift circuit 220 is moved to pre-amplifier circuit 250.

Variable phase shift circuit 220 may be implemented as a programmable phase interpolator. It should also be noted that the variable delay implemented by variable phase shift circuit 220 may instead be implemented as delay cells within pre-amplifier circuit 250. In some cases, the delay cells may be programmably variable. Based upon the disclosure provided herein, one of ordinary skill in the art will recognize a variety of implementations of delay circuits that may be used in relation to different embodiments of the present invention.

Although FIG. 2 shows distinct heat and magnetic write data signals, one or both may be multiplexed onto other pre-amplifier pins, to conserve flex and die area. Pre-amplifier circuit 250 includes a phase control circuit 271 that is operable to control the aforementioned calibration process. An output driver 260 receives heat write signal 245 and provides a corresponding differential excitation signal 282 to heat source 280; and an output driver 255 receives pre-compensated write signal 247 and provides a corresponding differential excitation signal 292 to write head 290. Phase control circuit 271 provides an enable signal 273 to output driver 260 and output driver 255. In addition, phase control circuit 271 calculates or detects a phase offset between differential excitation signal 292 (provided as an interim output 256) and differential excitation signal 282 (provided as an interim output 261). In some cases, driver 255 and driver 260 are implemented as a cascade of circuits which begins are the receivers of signals 247 and 245, respectively, and ends at the high power drivers of write head 290 and heat source 280. To assure accommodation of as many potential path differences between exciting heat source 280 and exciting write head 290, it is beneficial to determine the phase difference between differential excitation signal 292 and differential excitation signal 282 close to heat source 280 and write head 290. Thus, in some embodiments of the present invention, a series of output drivers may be used in place of output driver 255 and output driver 260 with a final stage output driver driving the respective differential excitation signal 292 and differential excitation signal 282 and a prior output driver providing the respective interim signal 256 and interim signal 261 to detect the phase offset by phase control circuit 271. In some cases, the circuits are implemented to allow phase control circuit 271 to receive its inputs from circuit 255 and circuit 260 as near as possible to the driven write head 290 and heat source 280. Where heat source 280 is a laser and heat write signal 245 is used to stimulate the laser, properly phased laser illumination of the medium relative to the transitions of a magnetic field generated by write head 280 enhances storage capability.

During calibration to phase the heat source and the write signals, controller circuit 270 signals phase control circuit 271 via control signals 272 to disable output driver 255 and output driver 260 such that differential excitation signal 292 and differential excitation signal 282 are not driven, while still driving interim signal 256 and interim signal 261. In addition, controller circuit 270 writes a zero phase offset value to programmable phase shift value register 225 via control signals 274. A data pattern is provided as write data 201, and is processed and ultimately provided as interim signal 256 and interim signal 261. Phase control circuit 271 calculates or detects a phase offset between interim signal 256 and interim signal 261. The negative of the calculated phase offset represents a null offset and is provided as control signals 272 to controller circuit 270. Controller circuit 270 writes the null offset to programmable phase shift value register 225. As with many circuits including others in this disclosure, controller circuit may be implemented either in hardware or firmware, or a combination of both hardware and firmware. The process is then repeated using a non-zero phase shift implemented by variable phase shift circuit 220. Phase control circuit 271 calculates the updated phase offset that is provided back to controller circuit 270. Controller circuit 270 determines whether the updated phase offset is less than a threshold. Where it is less than a threshold, the calibration is considered complete, and phase control circuit re-enables output driver 255 and output driver 260. Alternatively, where the phase offset is not less than the threshold, the negative of the updated phase offset is added to the value in programmable phase shift value register 225 and the calibration process is repeated using the new phase shift value. Alternatively or in addition to the above mentioned calibration approach, the phase offset information may be periodically obtained and used to perform a non-iterative correction to the variable delay applied by variable phase shift circuit 220.

As just some advantages of the aforementioned approach, by setting the value in programmable phase shift value register 225, the phase offset between heat source 280 and write head 290 can be controlled. Such phase offset may be caused by, for example, geometric mismatch and environmentally-induced transit delay shifts in the laser- and magnetic-drive paths.

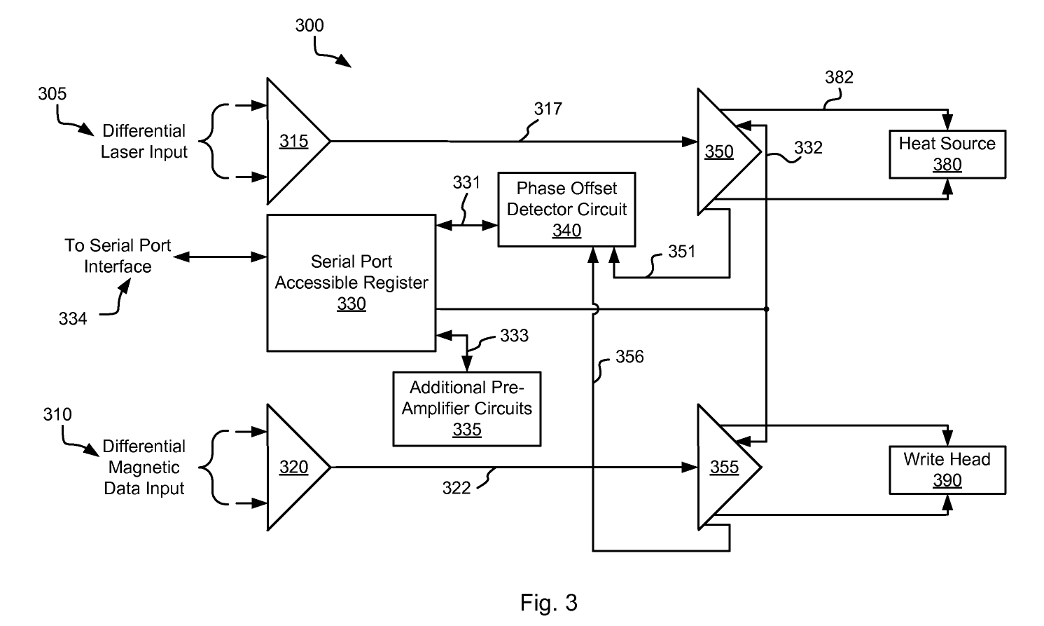

Turning to FIG. 3, an implementation of a pre-amplifier circuit 300 including a phase offset detector is shown in accordance with various embodiments of the present invention. Pre-amplifier circuit 300 includes a differential receiver 315 that receives a differential laser input 305, and a differential receiver 320 that receives a differential magnetic data input 310. Differential magnetic input 310 corresponds to pre-compensated write signal 247, and differential laser input corresponds to heat write signal 245. Receiver 315 provides a laser output 317 to an output driver 350 that provides a corresponding differential excitation signal 382 to heat source 380 which in this case is pulsed laser. Receiver 320 provides a write output 322 to an output driver 355 that provides a corresponding differential excitation signal 392 to write head 390 which in this case is an MR head. It should be noted that while receiver 315 and receiver 320 are shown as differential receivers, one or both may be implemented as single ended receivers. Similarly, it should be noted that while output driver 350 and output driver 355 are shown as differential drivers, one or both may be implemented as single ended drivers.

A serial port accessible register 330 provides one or more control values for the various circuits maintained in the pre-amplifier circuit 335 that may be set and read via a serial port interface 334. Serial port interface 334 corresponds to control signals 272. One of the values maintained in serial port accessible register 330 corresponds to an enable signal 332 provided to output driver 350 and output driver 355. In addition, serial port accessible register 330 includes a phase offset value received via signals 331 from a phase offset detector circuit 340. Yet further, serial port accessible register 330 provides various other values provided to and received from additional pre-amplifier circuits 335 via signals 334. Phase offset detector circuit 340 calculates or detects a phase offset between an interim signal 351 (corresponding to differential excitation circuit 382) and an interim signal 356 (corresponding to differential excitation circuit 392). The detected or calculated phase offset value is written to a register in serial port accessible register 330 via signals 331 where it can be read via serial port interface 334. To assure accommodation of as many potential path differences between exciting heat source 380 and exciting write head 390, it is beneficial to determine the phase difference between differential excitation signal 392 and differential excitation signal 382 close to heat source 380 and write head 390. Thus, in some embodiments of the present invention, a series of output drivers may be used in place of output driver 350 and output driver 355 with a final stage output driver driving the respective differential excitation signal 392 and differential excitation signal 382 and a prior output driver providing the respective interim signal 351 and interim signal 356 to detect the phase offset by phase control circuit 340.

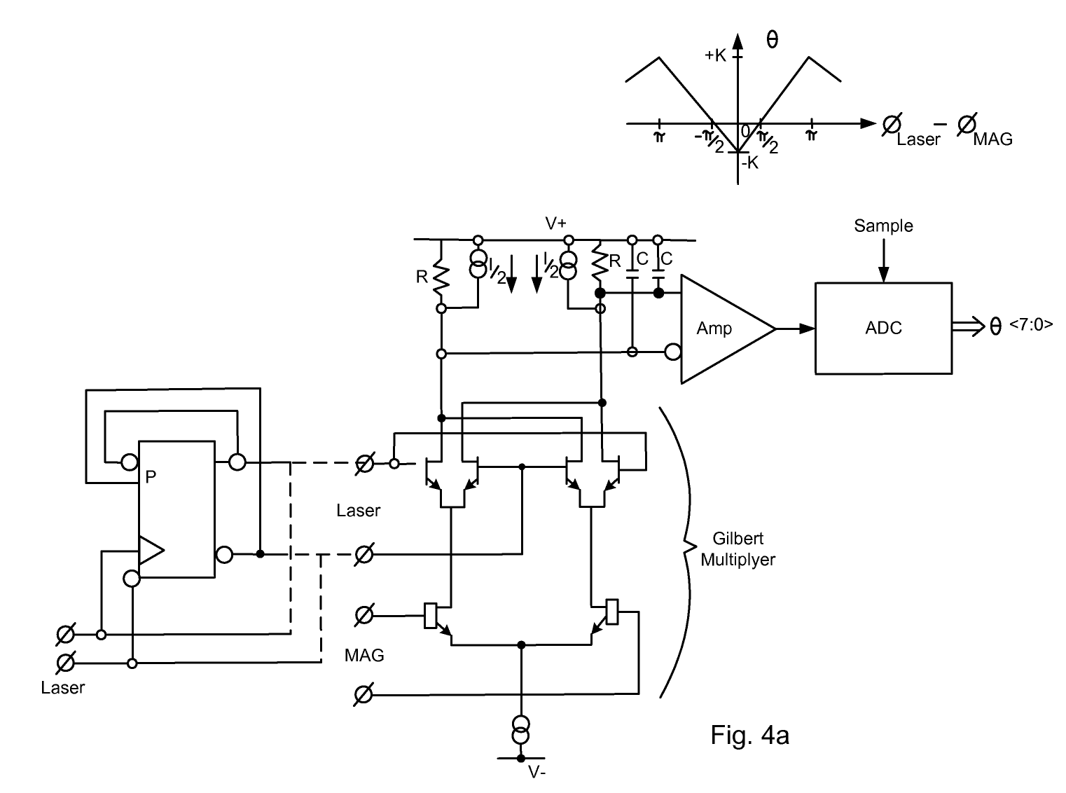

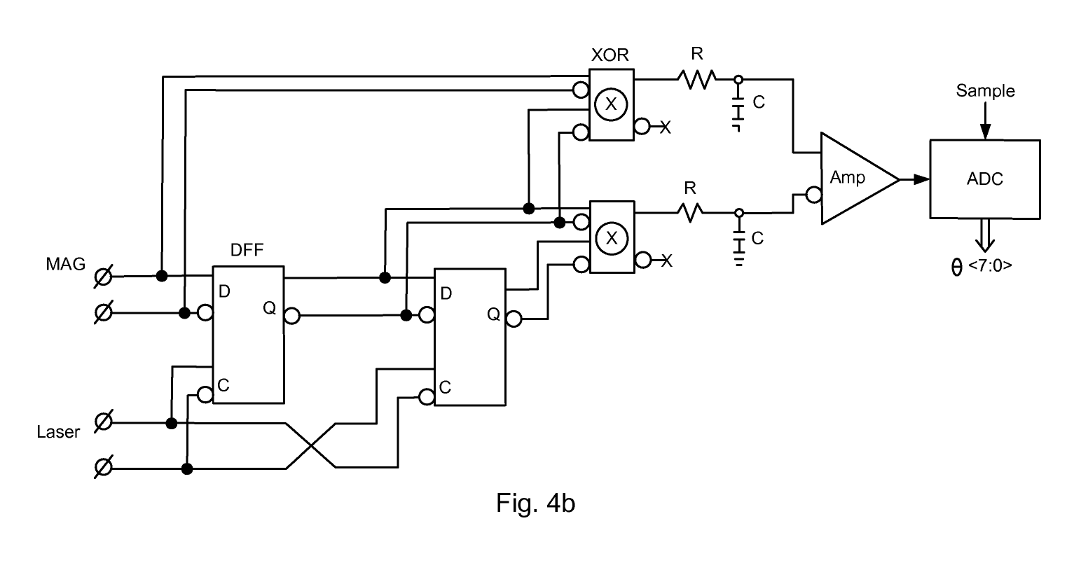

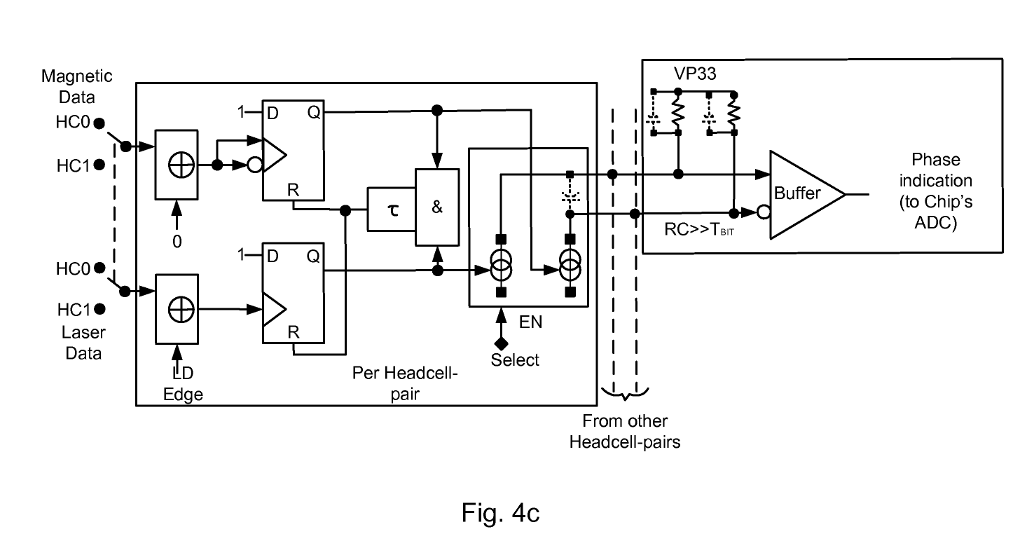

Turning to FIGS. 4a-4c, examples of phase offset detector circuits that may be used in relation to different embodiments of the present invention are shown. In particular, FIG. 4a depicts a phase offset detector circuit using a conventional saturating/current-routing Gilbert multiplier as an exclusive-or phase detector. The outputs are filtered by an R-C load, amplified by an amplifier with the amplified output being applied to an analog to digital converter circuit which includes a track-hold function. The multiplier tail current (I) is offset by currents (I/2) in each output leg. An optional divide-by-two function may be introduced into the Laser input of the phase detector if the Laser drive undergoes a full on/off cycle in each magnetic 1 T bitcell. Such a phase detector and companion divider are preferably realized as current mode, bipolar, circuits. As shown FIG. 4a, the phase detector has a cyclic detection range of +/−π radian. FIG. 4b illustrates an edge-sensitive, sequential realization of a phase offset detector circuit having the ability to perform phase detection on random write data, provided that the laser input is a pulse train at the baud rate (a complete laser on-off cycle in each 1 T bit cell). The latter constraint is expected to be satisfied by many heat-assisted magnetic recording formats. The phase detector is an implementation based on Hogge's concept that is discussed in C. R. Hogge, “A Self-Correcting Clock Recovery Circuit,” IEEE J. Lightwave Techn., Vol. 3, December 1985, p. 1312. The entirety of the aforementioned reference is incorporated herein by reference for all purposes. Phase detector circuit gain but not phase null-point is a function of transition density. The Detection range is +/−π radian of the laser input. A benefit of the phase detector circuit of FIG. 4b is its ability to function throughout the data record, since it responds only when data transitions are present on the magnetic data input. In some cases, the data record may contain irregularly spaced data transitions. The Lead/Lag signals delivered by the exclusive-or gates are filtered, amplified and buffered, and applied to the analog to digital converter circuit. Cyclic detection range is +/−π radian of the laser input, and the range relative to the input frequency can be enlarged if necessary by pre-division of the laser data input and the magnetic data input provided to the phase detector circuit. FIG. 4c depicts yet another phase offset detector circuit capable of a +/−2 pi linear range that may be used in relation to different embodiments of the present invention. The detector of FIG. 4c relies on a constant frequency of the introduced data. It should be noted that the phase detector circuits depicted in FIGS. 4a-4c are examples, and that one of ordinary skill in the art will recognize other implementations of phase detector circuits that may be used in relation to different embodiments of the present invention.

Turning to FIG. 5, a flow diagram 500 shows a method in accordance with some embodiments of the present invention for performing phase alignment in a recording channel. Following flow diagram 500, both magnetic and laser output drivers are disabled (block 505). This disabling turns off the output drivers such that they cannot provide excitation signals to a write head and a heat source disposed in relation to a storage medium. However, the output drivers remain capable of receiving and reacting to input signals, just not driving the excitation signals to the write head and heat source. In addition, a phase detector circuit is enabled (block 510). As such, the phase detector circuit is rendered able to detect or calculate a phase difference between a heat control signal directed to the heat source and a write control signal directed to the write head.

A phase aligned pattern is applied to both a laser data path and a magnetic data path (block 515). Such a phase aligned pattern may be applied by, for example, providing a single data pattern as an input and then providing the input down separate laser and magnetic processing paths. The phase detector circuit detects or calculates the phase offset between the laser data (i.e., the data stream used to generate a laser pulse) that is processed and provided to the laser output driver and the magnetic data (i.e., the data stream used to generate the magnetic write output) that is processed and provided to the magnetic output driver (block 520). This may be done using any phase detection circuit or approach known in the art. The detected or calculated phase offset is stored as a null offset value (block 525), and a gain is calculated (block 530).

Of note, due to circuit tolerances, the null point of the phase detector and the gain are calibrated prior to the aforementioned phase offset and gain calculations and storage. Nullpoint calibration may be accomplished by multiplexing the inputs to the phase detector circuit (i.e., the magnetic path input and the laser path input) to receive a common signal, or by forcing a zero-phase state in the comparator of the phase detector circuit. The resulting static offset defines the nullpoint. Gain is calibrated by commanding a known phase change in the channel, and recording the resultant change in the phase detector output. Knowledge of the phase detector gain supports an arbitrary shift of relative magnetic-to-laser data timing, to optimize recording quality. As phase-detector gain is proportional to transition density, gain calibration must occur with known data. Such gain calibration includes: (1) setting a variable phase shift circuit to apply a first phase shift (ψ1), and measuring a phase offset (θ1) corresponding to the first phase shift, (2) setting the variable phase shift circuit to apply a second phase shift (ψ2), and measuring a phase offset (θ2) corresponding to the second phase shift, and (3) calculating the gain in accordance with the following equation:

$$Gain = \frac{θ2 - θ1}{ψ2 - ψ1} bit / radian .$$

An initial offset value is calculated based on the null offset value (block 535). This calculation may include any modification of the numerical representation of the phase offset provided by the phase detector into a value useful by a variable phase delay circuit. This initial offset value is stored to an offset register (block 540). A pattern is applied to both the laser data path and the magnetic data path where the pattern applied to the laser data path is offset by the value previously stored in the offset register (block 545). This may be done, for example, by providing a write data input to both the laser data path and the magnetic data path. A variable phase delay circuit applies a phase delay to the laser data path that corresponds to the value previously stored in the offset register. The phase detector circuit then re-calculates the phase offset between the signals near the laser output driver and the magnetic output driver (i.e., near the head including the write head and the heat source) (block 550).

The calculated or detected phase offset is compared with a threshold (block 555). In some cases, the threshold is variable and calculated based on the following equation:

Threshold=(Programmed Percentage)(Initial Offset Value+Gain·X),

where the programmed percentage is a user selected variable or a fixed value, and X is the current data input. Where the phase offset is less than the threshold (block 555), the magnetic and laser output drivers are re-enabled (block 560), and the phase detector circuit is disabled (block 565). Alternatively, where the phase offset is not less than the threshold (block 555), the offset value is adjusted in the opposite direction of the phase offset provided by the phase detector circuit (block 570). This adjusted offset value is stored to the offset register (block 575), and the processes of blocks 545-575 are repeated for the adjusted offset value.

In cases of uncorrected phase offset between the magnetic data path and the laser data path that exceed one bit time, a coarse setting of the variable delay applied by variable phase shift circuit 220 can be obtained by commencing with a low-frequency test tone, nulling the comparator there, and continuing the sequence using test tones of ascending frequency. In situations where system parameters demand exact alignment of the laser data path and the magnetic data path, then the previously discussed phase detector gain calibration may be eliminated. Pattern-insensitivity of phase detector enables phase measurement to occur continuously in the random write data stream in the phase detectors of FIGS. 4a and 4b. In contrast, the phase detector of FIG. 4c relies on a periodic pattern. Of note, the aforementioned calibration may not account for all elements or processes in one or both of the laser data path or the magnetic data path. For example, the difference in switching dynamics of the heat source and the write head are not accounted for as the phase detection is based only on the signals provided to heat source and the write head. In such cases, these unaccounted elements may be estimated and corrected if necessary by iterative means or by feed forward based on independent environmental measurements. Alternatively, phase correction may be performed entirely within a pre-amplifier circuit using a delay lock loop scheme as are known in the art.

Turning to FIG. 6, a write portion 600 of a heat assisted magnetic recording system including both phase alignment control and a heat write pre/post emphasis circuit is shown in accordance with one or more embodiments of the present invention. Write portion 600 includes a portion of a read channel circuit 610, a portion of a pre-amplifier circuit 650, a heat source 680, and a write head 690. Write head 690 and heat source 680 are disposed near the surface of a storage medium (not shown) and a used to write data to the storage medium. Write head 690 may be any circuit or device known in the art that is capable of generating a magnetic field sufficiently large to magnetize a defined region of the storage medium. As just one example, write head 690 may be a magneto-resistive (MR) write head as are known in the art. Based upon the disclosure provided herein, one of ordinary skill in the art will recognize a variety of write heads that may be used in relation to different embodiments of the present invention. In some embodiments of the present invention, heat source 680 is a laser as is known in the art. When excited, the laser generates heat at the defined location where a write is occurring. Based upon the disclosure provided herein, one of ordinary skill in the art will recognize a variety of heat sources including, but not limited to, specific types of lasers that may be used in relation to different embodiments of the present invention.

A controller circuit 670 is included that provides control signals 672 to pre-amplifier circuit 650, and control signals 674 to read channel circuit 610. Control circuit 670 may be any circuit capable of providing control to the operations of write portion 600. In some embodiments of the present invention, control circuit 670 includes a microcontroller that executes firmware as are known in the art. Based upon the disclosure provided herein, one of ordinary skill in the art will recognize a variety of control circuits that may be used in relation to different embodiments of the present invention.

Read channel circuit 610 includes a master clock circuit 615 that generates a clock signal 617 to which write operations are synchronized. In some cases, the phase and frequency of clock signal 617 are adjusted by master clock circuit 615 based upon servo data read from the storage medium. Based upon the disclosure provided herein, one of ordinary skill in the art will recognize a variety of clock circuits that may be used in relation to different embodiments of the present invention.

Write data 601 destined for storage to the storage medium may be received from an upstream source (not shown). Such write data may be received as a series of WORDS which each contain a number of individual bits. Such WORDS may be, but are not limited to, thirty-two bit words, sixty-four bit words, or one hundred, twenty-eight bit words. Based upon the disclosure provided herein, one of ordinary skill in the art will recognize a variety of source from which write data 601 may be received, and a number of formats that write data 601 may exhibit. Write data 601 is received by a magnetic write encoder circuit 630 and encoded in preparation for writing as magnetic information on a storage medium. The resulting data are provided as encoded data 632 to a data serializer circuit 635. Magnetic write encoder circuit 630 may be any circuit known in the art that receives data and encodes that data in preparation for writing as magnetic information to a storage medium. Data serializer circuit 635 accepts encoded data 632 at an input clock rate, and provides a serial data stream 637 at an output clock rate. As an example, where encoded data are received eight bits at a time, serial data stream 637 may be provided at eight times the rate of the input clock.

Serial data stream 637 is provided to a magnetic write pre-compensation circuit 640 that pre-compensates the received data and provides a pre-compensated write signal 647 to pre-amplifier circuit 650. It is customary to pre-compensate the magnetic write data signal to counteract the bit-shift effect of adjacent transition patterns, and magnetic write pre-compensation circuit 640 may be any circuit known in the art that is capable of pre-compensating a data input in preparation for writing to a storage medium. Of note, in some embodiments read channel circuit 610 and pre-amplifier circuit 650 are implemented in separate physical packages. In some such cases, pre-compensated write signal 647 is provided to pre-amplifier circuit 650 via a flexible connector. While it is not shown, in some embodiments of the present invention, heat data may also be pre-compensated. In such cases, read channel circuit 610 would additionally include a heat data pre compensation circuit.

In addition, serial data stream 637 is provided to a variable phase shift circuit 620 that operates to phase delay serial data stream 637 in time according to a phase delay value 627 to yield a delayed serial output 638 that is provided to a heat write pre/post emphasis circuit 695 that is part of pre-amplifier circuit 650. Heat write pre/post emphasis circuit 695 applies an emphasis to the received signal, and the emphasized signal is provided as a heat write signal 645 to pre-amplifier circuit 650. Application of the emphasis is more fully described below.

The phase delay applied by variable phase shift circuit 620 operates to modify the relative alignment of heat write signal 645 and pre-compensated write signal 647 in accordance with the following equation:

Phase Offset=φ_{Heat Write Signal}−φ_{Pre-Compensated Write Signal},

where φ_{Heat Write Signal} is the phase of heat write signal 645 and φ_{Pre-Compensated Write Signal} is the phase of pre-compensated write signal 647. Of note, as depicted only a positive phase shift is possible as variable phase shift circuit 620 only applies a phase delay to serial data stream 637. However, in some embodiments of the present invention, magnetic write pre-compensation circuit 640 applies a fixed delay to serial data stream 637 as part of generating pre-compensated write signal 647. As such, where variable phase shift circuit 620 applies a phase delay less than the fixed delay applied by magnetic write pre-compensation circuit 640, an effective negative delay can be applied to heat write signal 645 in accordance with the following equation:

Phase Offset=φ_{Heat Write Signal}−φ_{Pre-Compensated Write Signal}+φ_{Fixed},

where φ_{Fixed} is the fixed delay applied by magnetic write pre-compensation circuit 640. Phase delay value 627 is written to a programmable phase shift value register 625 by controller circuit 670 as part of a calibration process similar to that described above in relation to FIG. 2.

Variable phase shift circuit 620 may be implemented as a programmable phase interpolator. It should also be noted that the variable delay implemented by variable phase shift circuit 620 may instead be implemented as delay cells within pre-amplifier circuit 650. Based upon the disclosure provided herein, one of ordinary skill in the art will recognize a variety of implementations of delay circuits that may be used in relation to different embodiments of the present invention.

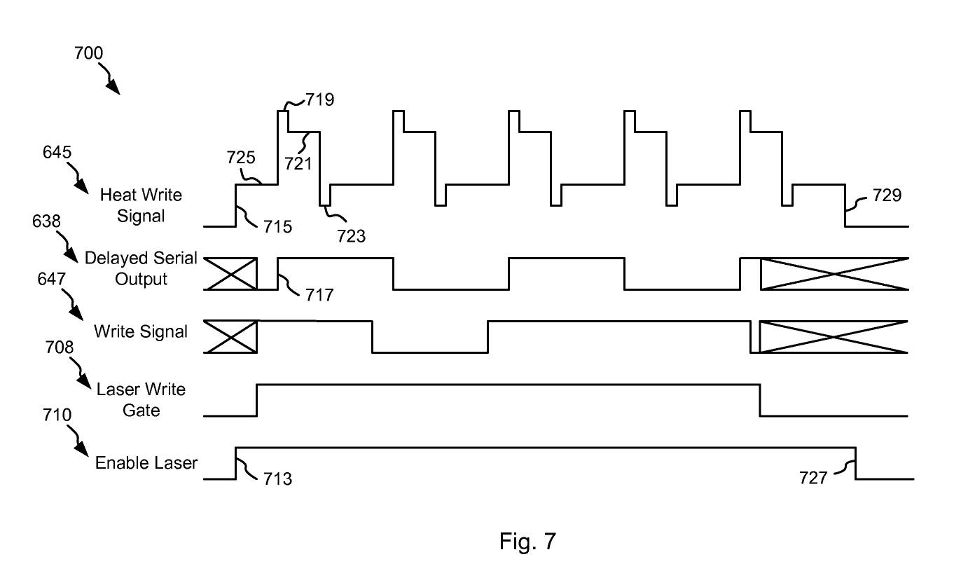

As mentioned, pre-amplifier circuit 650 includes heat write pre/post emphasis circuit 695 increases the amplitude heat write signal 645 corresponding to an initial transition of delayed serial output 638 to create an overshoot, and decreases the amplitude heat write signal 645 corresponding to a subsequent transition of delayed serial output 638 to create an undershoot. FIG. 7 is a timing diagram 700 showing pre/post emphasis on a heat write in accordance with various embodiments of the present invention. As shown, when a laser enable 710 transitions 713 to an asserted state to enable operation of heat source 680, heat write signal 645 transitions 715 from a laser off level to a stable threshold 725 just short of stimulating emission of the laser. Upon an initial transition 717 of a delayed serial output 638, heat write signal 645 is driven to an emphasized threshold 719 that is above an on threshold 721 of the laser. Heat write signal 645 remains in this overshoot state for an emphasis period, and then relaxes to on threshold 721. After the emission period of the laser, heat write signal 645 is driven to an emphasized threshold 723 below stable threshold 725. Heat write signal 645 remains in this undershoot state for the emphasis period, and then relaxes to stable threshold 725. This process of pulsing heat write signal corresponding to transitions of delayed serial output 638 continues until a laser write gate 708 is de-asserted and the enable laser signal 710. The de-assert transition of enable laser signal 710 causes heat write signal to transition 729 to an off level. It should be noted that timing diagram 700 is an example showing emphasis on a positive transition and a negative transition, and that many different timing diagrams and signal relationships may be generated by heat write pre/post emphasis circuit 695. In some cases, only pre-emphasis may be applied, while in other cases only post-emphasis may be applied. Further, the period over which post emphasis is applied may be different from the period over which pre-emphasis is applied. Based upon the disclosure provided herein, one of ordinary skill in the art will recognize a variety of signal waveforms including one or both of pre-emphasis and post-emphasis that may be generated by heat write pre/post emphasis circuit 695 in accordance with different embodiments of the present invention.

Although FIG. 6 shows distinct heat and magnetic write data signals, one or both may be multiplexed onto other pre-amplifier pins, to conserve flex and die area. Pre-amplifier circuit 650 includes a phase control circuit 671 that is operable to control the aforementioned calibration process. An output driver 660 receives heat write signal 645 and provides a corresponding differential excitation signal 682 to heat source 680; and an output driver 655 receives pre-compensated write signal 647 and provides a corresponding differential excitation signal 692 to write head 690. Phase control circuit 671 provides an enable signal 673 to output driver 660 and output driver 655. In addition, phase control circuit 671 calculates or detects a phase offset between differential excitation signal 692 (provided as an interim output 656) and differential excitation signal 682 (provided as an interim output 661). To assure accommodation of as many potential path differences between exciting heat source 680 and exciting write head 690, it is beneficial to determine the phase difference between differential excitation signal 692 and differential excitation signal 682 close to heat source 680 and write head 690. Thus, in some embodiments of the present invention, a series of output drivers may be used in place of output driver 655 and output driver 660 with a final stage output driver driving the respective differential excitation signal 692 and differential excitation signal 682 and a prior output driver providing the respective interim signal 656 and interim signal 661 to detect the phase offset by phase control circuit 671. As just some advantages of the aforementioned pre/post emphasis approach, turn on and/or turn off times exhibited by a laser used as heat source 680 may be reduced, and the temporal stability of the optical profile can be improved.

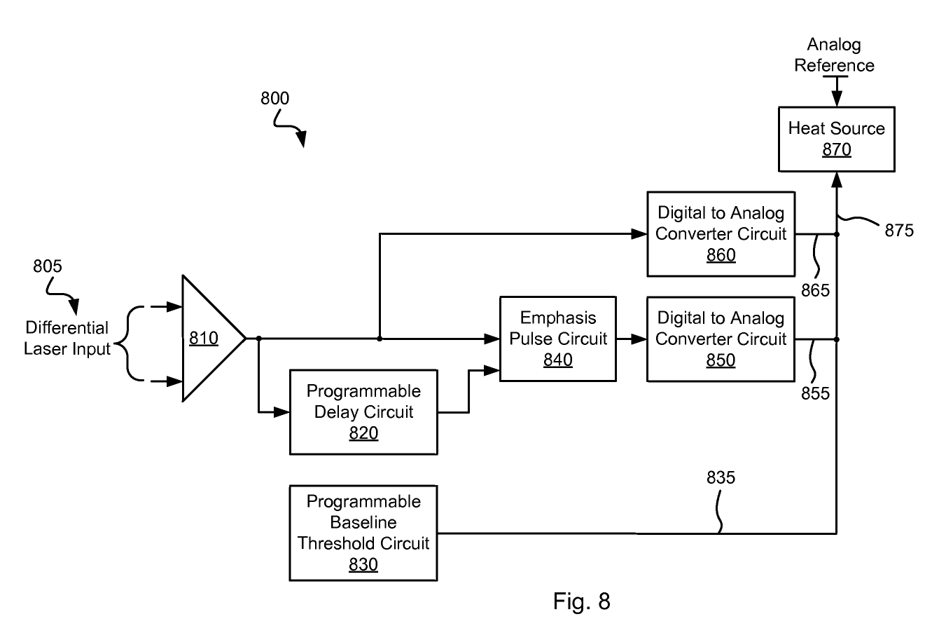

Turning to FIG. 8, a pre/post emphasis circuit 800 is shown in accordance with one or more embodiments of the present invention. Pre/post emphasis circuit 800 includes a differential receiver 810 that receives a differential laser input 805. Differential laser input 805 corresponds to delayed serial output 638. It should be noted that delayed serial output 638 may be single ended in which case differential receiver 810 would be replaced by a single ended receiver circuit. Receiver 810 provides an un-emphasized signal 815 to a programmable delay circuit 820, an emphasis pulse circuit 840, and a digital to analog converter circuit 860. Digital to analog converter circuit 860 provides an analog output 865 corresponding in amplitude and pattern of un-emphasized signal 815.

Programmable delay circuit delays un-emphasized signal by a programmably defined amount to yield a delayed output 825. The amount of programmed delay corresponds to the duration of the emphasis period as shown in FIG. 7. Emphasis pulse circuit 840 causes a positive emphasis pulse to be generated for a duration corresponding to delayed output whenever un-emphasized signal 815 transitions; and generates a negative emphasis pulse to be generation for a duration corresponding to delayed output at the end of the laser pulse period. This combination of positive emphasis and negative emphasis pulses are provided as an emphasis output 845 to a digital to analog converter circuit 850. Digital to analog converter circuit 850 provides an analog output 855 corresponding in amplitude and pattern of emphasis output 845.

A programmable baseline threshold circuit 830 provides a DC analog output 835 with an amplitude that corresponds to the stable threshold of the laser being driven (e.g., threshold 725). Programmable baseline threshold circuit 830 may be, for example, a register holding a programmable digital value and a digital to analog converter circuit operable to convert the digital value to a corresponding analog output. Analog output 865, analog output 855 and analog output 835 are summed to yield a laser excitation output 875 that is provided to a heat source 870. In some cases, both pre-emphasis and post-emphasis is provided by a high speed bipolar-output digital to analog converter circuit that delivers a current that may be programmably set.

It should be noted that the various blocks discussed in the above application may be implemented in integrated circuits along with other functionality. Such integrated circuits may include all of the functions of a given block, system or circuit, or only a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

Turning to FIG. 9, an implementation of a pre-amplifier circuit 900 including a phase offset detector circuit 940 and phase shift circuits 918, 923 is shown in accordance with various embodiments of the present invention. Phase shift circuits 918, 923 may be used in place of variable phase shift circuit 220 of FIG. 2 where the phase shift is implemented in the pre-amplifier circuit instead of the read channel circuit. Pre-amplifier circuit 900 includes a differential receiver 915 that receives a differential laser input 905, and a differential receiver 920 that receives a differential magnetic data input 910. Differential magnetic input 910 corresponds to pre-compensated write signal 247 discussed above in FIG. 2, and differential laser input corresponds to an un-shifted heat write signal 245 discussed above in relation to FIG. 2. Receiver 915 provides a laser output 917 to a phase shift circuit 918, and the output of phase shift circuit 918 is provided to an output driver 950 that provides a corresponding differential excitation signal 982 to heat source 980 which in this case is pulsed laser. Receiver 920 provides a write output 922 to a phase shift circuit 923, and the output of phase shift circuit 923 is provided to an output driver 955 that provides a corresponding differential excitation signal 992 to write head 990 which in this case is an MR head. It should be noted that while receiver 915 and receiver 920 are shown as differential receivers, one or both may be implemented as single ended receivers. Similarly, it should be noted that while output driver 950 and output driver 955 are shown as differential drivers, one or both may be implemented as single ended drivers.

A serial port accessible register 930 provides one or more control values for the various circuits maintained in the pre-amplifier circuit 935 that may be set and read via a serial port interface 934. Serial port interface 934 corresponds to control signals 272 and phase delay value 227. Phase delay value 227 is provided to one of phase shift circuits 918, 923 to implement the selected phase delay. Another of the values maintained in serial port accessible register 930 corresponds to an enable signal 932 provided to output driver 950 and output driver 955. In addition, serial port accessible register 930 includes a phase offset value received via signals 931 from a phase offset detector circuit 940. Yet further, serial port accessible register 930 provides various other values provided to and received from additional pre-amplifier circuits 935 via signals 934. Phase offset detector circuit 940 calculates or detects a phase offset between an interim signal 951 (corresponding to differential excitation circuit 982) and an interim signal 956 (corresponding to differential excitation circuit 992). The detected or calculated phase offset value is written to a register in serial port accessible register 930 via signals 931 where it can be read via serial port interface 934. To assure accommodation of as many potential path differences between exciting heat source 980 and exciting write head 990, it is beneficial to determine the phase difference between differential excitation signal 992 and differential excitation signal 982 close to heat source 980 and write head 990. Thus, in some embodiments of the present invention, a series of output drivers may be used in place of output driver 950 and output driver 955 with a final stage output driver driving the respective differential excitation signal 992 and differential excitation signal 982 and a prior output driver providing the respective interim signal 951 and interim signal 956 to detect the phase offset by phase control circuit 940. By including both phase shift circuits 918, 923, both positive phase shifts (differential excitation signal 982 delayed relative to differential excitation signal 992 caused by a delay from phase shift circuit 918) and negative phase shifts (differential excitation signal 992 delayed relative to differential excitation signal 982 caused by a delay from phase shift circuit 923) are possible.

In conclusion, the invention provides novel systems, devices, methods and arrangements for data storage. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

1. A heat assisted data write circuit, the circuit comprising:
a heat write output;
a magnetic write output; and
a variable phase shift circuit operable to modify a relative phase of the heat write output to the magnetic write output.

2. The circuit of claim 1, wherein the circuit further comprises:
a programmable phase shift value register operable to maintain a phase shift value, wherein a delay implemented by the variable phase shift circuit corresponds to the phase shift value.

3. The circuit of claim 1, wherein a derivative of the magnetic write output is provided as an excitation signal to a write head, and a derivative of the heat write output is provided as an excitation signal to a heat source.

4. The circuit of claim 3, wherein the circuit further comprises:
a phase detector circuit operable to determine a phase offset between the heat write output and the magnetic write output.

5. The circuit of claim 4, wherein the circuit further comprises:
a controller circuit operable to determine the phase shift value based at least in part on the phase offset between the heat write output and the magnetic write output, and to store the phase shift value to the programmable phase shift value register.

6. The circuit of claim 3, wherein the write head is a magneto-resistive write head, and wherein the heat source is a laser.

7. The circuit of claim 1, wherein the circuit further comprises:
a fixed phase shift circuit operable to apply a fixed phase shift to one of the heat write output and the magnetic write output; and
wherein the variable phase shift circuit is operable to apply a variable phase shift to the other of the heat write output and the magnetic write output.

8. The circuit of claim 1, the circuit further comprising:
a heat write emphasis circuit operable to emphasize at least one transition of the heat write output.

9. The circuit of claim 8, the circuit further comprising:
a heat source; and
an output driver operable to receive the heat write output and to drive an excitation signal corresponding to the heat write output to the heat source.

10. The circuit of claim 9, wherein the transition is a positive transition, wherein the heat source is a laser, and wherein the emphasis is an overshoot designed to cause the laser to turn on more quickly than would occur in the absence of the overshoot.

11. The circuit of claim 9, wherein the transition is a negative transition, wherein the heat source is a laser, and wherein the emphasis is an undershoot designed to cause the laser to turn off more quickly than would occur in the absence of the undershoot.

12. The circuit of claim 1, wherein the circuit is implemented as part of an integrated circuit.

13. The circuit of claim 1, wherein the circuit is deployed as part of a hard disk drive.

14-19. (canceled)

20. A data storage device, the data storage device comprising:
a storage medium;
a read/write head assembly disposed in relation to the storage medium, wherein the read/write head assembly includes a write head and a heat source;
a write circuit comprising:
a heat write output, wherein a derivative of the heat write output is operable to excite the heat source;
a magnetic write output, wherein a derivative of the magnetic write output is operable to excite the write head;
a variable phase shift circuit operable to modify a relative phase of the heat write output to the magnetic write output;
a programmable phase shift value register operable to maintain a phase shift value, wherein a delay implemented by the variable phase shift circuit corresponds to the phase shift value;
a phase detector circuit operable to determine a phase offset between the heat write output and the magnetic write output; and
a controller circuit operable to determine the phase shift value based at least in part on the phase offset between the heat write output and the magnetic write output, and to store the phase shift value to the programmable phase shift value register.

21. A heat assisted data write system, the system comprising:
a variable phase shift circuit operable to modify a relative phase of a heat write output to a magnetic write output.

22. The system of claim 21, wherein the system is implemented in an integrated circuit.

23. The system of claim 21, wherein the system further comprises:
a programmable phase shift value register operable to maintain a phase shift value, wherein a delay implemented by the variable phase shift circuit corresponds to the phase shift value.

24. The system of claim 21, wherein the system further comprises:
a write head;
a heat source; and
wherein a derivative of the magnetic write output is provided as an excitation signal to the write head, and wherein a derivative of the heat write output is provided as an excitation signal to the heat source.

25. The system of claim 21, wherein the system is a storage device.

26. The system of claim 21, wherein the system further comprises:
a phase detector circuit operable to determine a phase offset between the heat write output and the magnetic write output; and
a controller circuit operable to determine the phase shift value based at least in part on the phase offset between the heat write output and the magnetic write output, and to store the phase shift value to the programmable phase shift value register.
